(19) United States
(12) Patent Application Publication
(10) Pub. No.: US 2013/0283250 A1
(43) Pub. Date: Oct. 24, 2013

(54) Thread Specific Compiler Generated Customization of Runtime Support for Application Programming Interfaces

(71) Applicants: Alexandre E. Eichenberger, Chappaqua, NY (US); John K.P. O'Brien, South Salem, NY (US)

(72) Inventors: Alexandre E. Eichenberger, Chappaqua, NY (US); John K.P. O'Brien, South Salem, NY (US)

(73) Assignee: INTERNATIONAL BUSINESS MACHINES CORPORATION, Armonk, NY (US)

(21) Appl. No.: 13/453,411

(22) Filed: Apr. 23, 2012

(51) Int. Cl. G06F 9/45

(52) U.S. Cl. 717/144

(57) ABSTRACT

Mechanisms are provided for generating a customized runtime library for source code. Source code is analyzed to identify a region of code implementing an application programming interface or programming standard of interest. An invocation tree data structure is generated based on results of analysis of functions of the application programming interface or programming standard of interest that the region of code invokes. A custom runtime library is generated based on the invocation tree data structure. The custom runtime library comprises only a subset of runtime library functions, less than a total number of runtime library functions for the application programming interface or programming standard of interest, actually invoked by the region of code and does not include all runtime library functions in the total number of runtime library functions for the application programming interface or programming standard of interest.

This invention was made with United States Government support under Contract No. B554331 awarded by the Department of Energy. The Government has certain rights in this invention.

### BACKGROUND

The present application relates generally to an improved data processing apparatus and method, and more specifically to mechanisms for providing thread specific compiler generation customization of runtime support for application programming interfaces.

OpenMP (Open Multi-Processing) is an API (application programming interface) that supports multi-platform shared memory multiprocessing programming on most processor architectures and operating systems. OpenMP is an implementation of multithreading, which is a method of parallelization whereby a master “thread” (a series of instructions executed consecutively) “spawns” or “forks” a specified number of “slave” threads and a task is divided among them. The threads then run concurrently, with the runtime environment allocating threads to different processors.

The section of code that is meant to run in parallel is marked accordingly, with a preprocessor directive that will cause the threads to form before the section is executed. Each thread has an “id” attached to it which can be obtained using a function (called omp_get_thread_num( )). The thread id is an integer, and the master thread has an id of “0”. After the execution of the parallelized code, the threads “join” back into the master thread, which continues onward to the end of the program.

By default, each thread executes the parallelized section of code independently. Work-sharing constructs can be used to divide a task among the threads so that each thread executes its allocated part of the code. Both task parallelism and data parallelism can be achieved using OpenMP in this way.

OpenMP consists of a set of compiler directives, runtime library routines, and environment variables that influence run-time behavior. The runtime environment allocates threads to processors depending on usage, machine load, and other factors. The number of threads can be assigned by the runtime environment based on environment variables or in code using functions.

### SUMMARY

In one illustrative embodiment, a method, in a data processing system, is provided for generating a customized runtime library for source code. The method comprises analyzing, by the data processing system, source code to identify a region of code implementing an application programming interface or programming standard of interest. The method further comprises generating, by the data processing system, an invocation tree data structure based on results of analysis of functions of the application programming interface or programming standard of interest that the region of code invokes. Moreover, the method comprises generating, by the data processing system, a custom runtime library based on the invocation tree data structure. The custom runtime library comprises only a subset of runtime library functions, less than a total number of runtime library functions for the application programming interface or programming standard of interest, actually invoked by the region of code and does not include all runtime library functions in the total number of runtime library functions for the application programming interface or programming standard of interest.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is an example flowchart that outlines the overall operation of the compiler mechanisms of the illustrative embodiments for generating and utilizing a customized runtime library;

FIG. 4A is an example diagram illustrating a function call flow in accordance with one illustrative embodiment;

FIG. 4B is an example diagram of a compiler optimized function call flow in which the control flow is migrated inside the parallel region by breaking the function call into separate sub-functions;

FIG. 5A is an example diagram illustrating a region of source code in which a “get-thread-id” function call is made by worker threads;

FIG. 5B is an example diagram illustrating a region of source code in which the “get-thread-id” function call is not made by the worker threads;

FIG. 6 is a block diagram of a compiler in accordance with one illustrative embodiment; and

FIGS. 7A and 7B provide an example illustration of the ability of the illustrative embodiments to move sub-functions to achieve more efficient execution of code.

### DETAILED DESCRIPTION

The illustrative embodiments provide mechanisms for providing thread specific compiler generation customization of runtime support for application programming interfaces (APIs), such as the OpenMP API and the like. The OpenMP API will be used for purposes of explanation of the mechanisms of the illustrative embodiments, but the present invention is not limited to such and can be used with other suitable APIs without departing from the spirit and scope of the illustrative embodiments. OpenMP is selected as exemplary because it is currently the most prevalent programming model for shared memory parallelism, with a wide installation base, and is being used by a large number of application developers, as well as is supported by a large number of computer and software vendors.

The illustrative embodiments provide compiler based mechanisms for analyzing portions of source code to determine which parts of the API are actually being implemented by those portions of the source code and implements customized runtime libraries for these portions of source code that only implement the parts of the API actually used by the corresponding potion of source code. In this way, the entire runtime library for the API does not need to be implemented or supported when executing the compiled code during runtime, but only the portions of the runtime library actually used by the compiled code. In addition, to facilitate the customization of the runtime library for the API, the compiler based mechanisms of the illustrative embodiments determine which runtime library functions, that are utilized by the portions of the source code, can be broken down into sub-functions that can be individually implemented in a runtime library such that some sub-functions that are actually used by the portions of source code are included in the runtime library while other sub-functions that are not actually used by the portions of source code are not included in the runtime library.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

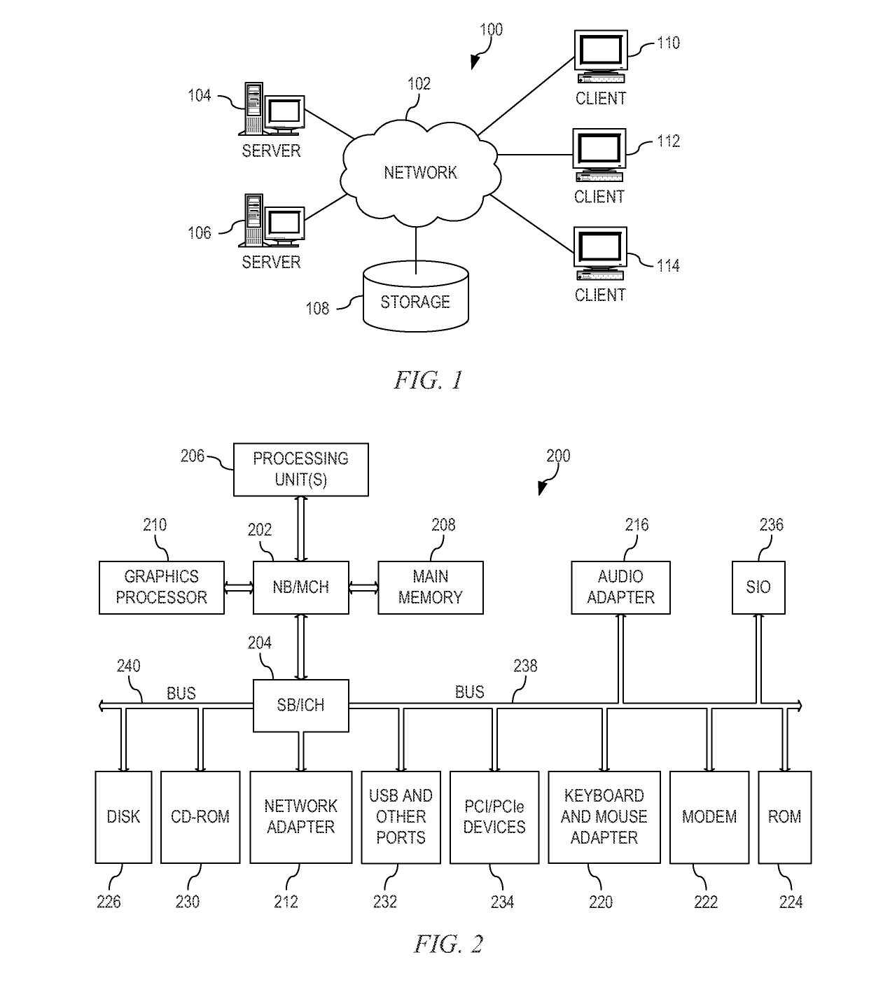

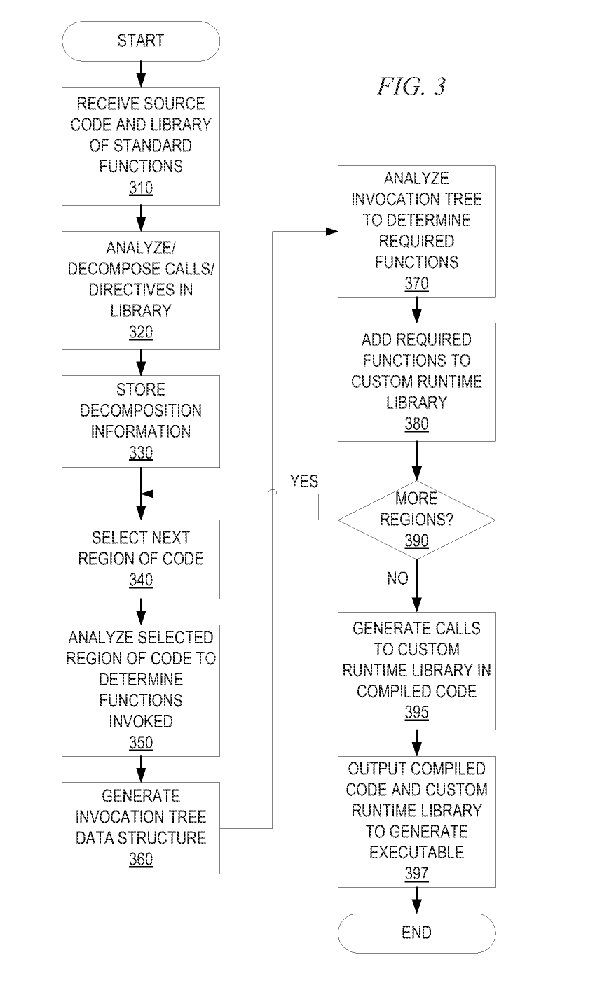

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCl/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

Most modern computer codes utilize runtime libraries to facilitate the performance of operations when the computer code is executed on a data processing system. A runtime library is a special program library used by a compiler to implement functions built into a programming language during the execution (runtime) of a computer program. This often includes functions for input and output or for memory management. Runtime libraries may also be used to implement functionalities required by a computer standard, such as standards for parallel processing, such as OpenMP. In this case, the functionality that is provided by the compiler and its associated libraries is well defined if the vendor offering the compiler and its associated libraries wants to be known as standard compliant.

When the source code of a computer program is translated into the respective target language by a compiler, there would be an extreme enlargement of program code if each command in the program, and every call to a built-in function, would cause the in-place generation of the complete respective program code in the target language every time. Instead the compiler often uses compiler-specific auxiliary functions in the runtime library that are mostly not accessible to application programmers. Depending on the compiler manufacturer, the runtime library will sometimes also contain the standard library of the respective compiler or be contained in it.

Currently, runtime libraries must be configured to provide support for a large set of commands, functions, and calls. That is, the runtime library provides support for all of the possible commands, functions, and calls that may be made in source code regardless of whether they are actually made in the particular source code being compiled. Thus, for example, a runtime library currently includes programs and support for all of functions A-Z even though the source code may only ever call function K and does not call functions A-J and L-Z. In other words, the runtime library is designed to satisfy all of the minute requirements of standard function calls, APIs, and the like, and must satisfy the semantics of these standard function calls, e.g., if a function call has a semantic that every call to the function must result in a call to “get-thread-id”, then this must be supported even though the particular source code may not ever use the thread id. Thus, the current implementation of runtime libraries is inefficient, causing larger storage requirements and increased latency as larger runtime libraries must be searched to find corresponding functions for those called by the executing code.

The illustrative embodiments provide mechanisms which leverage the compiler's knowledge of the subset of the APIs and other standard runtime library components that are actually used in any portion of source code to determine what subset of the APIs and other standard runtime library components need to be supported for each portion of the source code. That is, the compiler, in processing the portions of the source code, identifies what function calls and API calls are made by the source code in those portions. As a result, the compiler knows which subsets of the APIs and standard runtime library functions are actually used by the portions of source code in question. Based on this information, the compiler may generate a customized runtime library for the source code, or portions of the source code, which implements only the subsets of the APIs and standard runtime library that are actually used by the corresponding portion of source code.

To illustrate the manner by which the mechanisms of the illustrative embodiments provide beneficial results of generating customized runtime libraries, an example implementation will be described hereafter with regard to the OpenMP standard and source code that is an application utilizing the OpenMP standard. As discussed above, the OpenMP standard is an API that supports multi-platform shared memory multiprocessing programming which implements multithreading. The use of the OpenMP standard in the following examples is not to be construed as a limitation of the illustrative embodiments but is selected for illustrative purposes only. The mechanisms of the illustrative embodiments may be utilized with any API or standard set of runtime library functions which may be customized in accordance with the mechanisms of the illustrative embodiments.

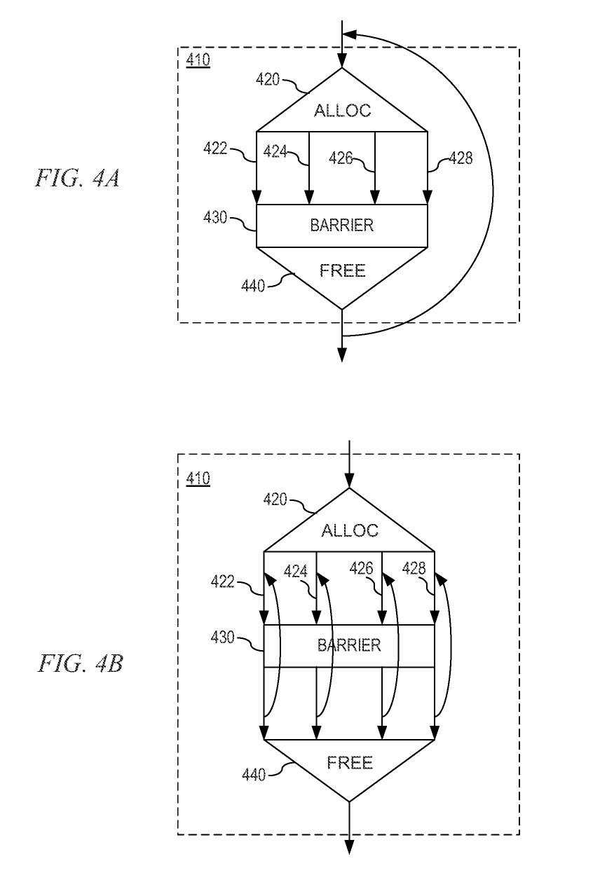

FIG. 3 is an example flowchart that outlines the overall operation of the compiler mechanisms of the illustrative embodiments for generating and utilizing a customized runtime library. Again, the example referenced in FIG. 3 is for an OpenMP standard and source code that is an OpenMP application. However, this is not intended to be limiting on the possible implementations and applications of the mechanisms of the illustrative embodiments.

As shown in FIG. 3, the compiler operation starts with receiving source code, e.g., an OpenMP application code, and one or more libraries of functions for the standard(s) implemented by the source code, e.g., OpenMP and/or the like (step 310). The compiler analyzes the one or more libraries of functions to determine, for each possible call or directive, the basic features of the call or directive that the call or directive may be decomposed into, i.e. the sub-parts or sub-functions of the call or directive that together comprise the called function or directive function (step 320). This information is then stored in a library call/directive decomposition data structure that is accessed by the compiler when generating a customized runtime library for the particular source code when compiling the source code (step 330).

The compiler then selects a next region of code that includes at least one construct corresponding to the standard(s), e.g., OpenMP standard (step 340). For example, using the OpenMP standard as an example, the compiler may select a region of code that is to be performed in parallel by spawning threads to execute the code in parallel, e.g., loops or the like. The compiler analyzes the selected region of code to gather information about the region of code (step 350). This process may involve considering all code that may be accessed from the selected region of code and detecting each directive and/or call, e.g., OpenMP directive or OpenMP call, in the region of code. From this gathered information, the compiler builds an invocation tree that identifies which portions of code call which other portions of code in turn (step 360).

The generated invocation tree is then analyzed by the compiler (step 370). The analysis of the invocation tree may involve, for example, using the semantics of each directive or call in the standard(s), traversing the tree in a depth-first fashion, and determining at each node in the tree what functionality of an optimized runtime library would be required by the node itself or any of its children. The particular required functions for the optimized runtime library are then added to a customized runtime library for the compiled source code (step 380). A determination is then made as to whether there are additional regions of the source code to be analyzed (step 390). If so, the operation returns to step 340. Otherwise, the compiler generates calls to the customized runtime library so that each identified directive/call instance satisfies at the minimum all of the requirements determined in the analysis of the invocation tree, i.e. step 370 (step 395). The operation outputs the compiled code that uses the customized runtime library to generate an executable code having appropriate calls to the customized runtime library (step 397). The operation then terminates.

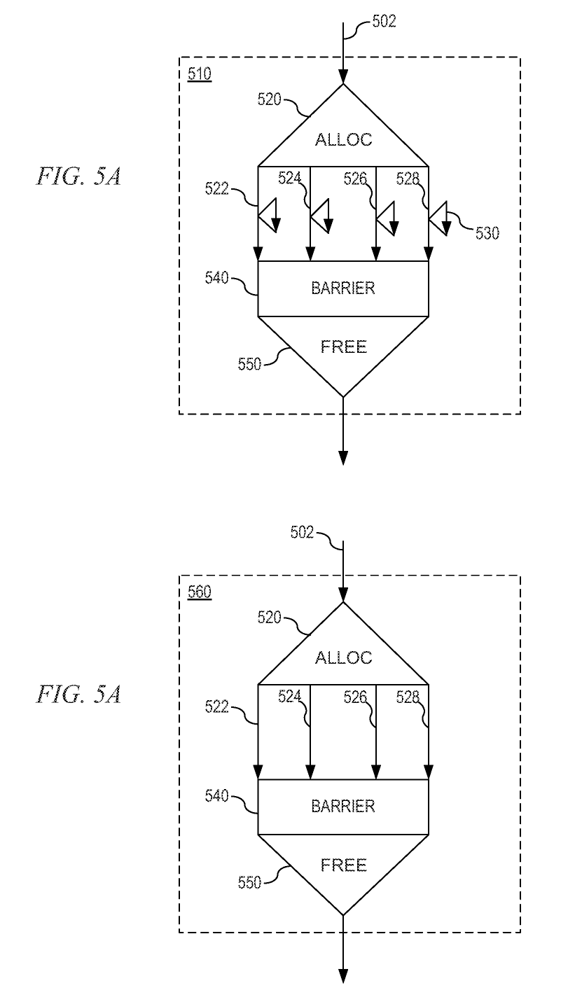

As mentioned above, the compiler selects regions of code to be analyzed for use with a customized runtime library. The compiler, in one illustrative embodiment, selects regions of code that are executed in parallel. Such parallel regions of code are often in loops within the source code. With such parallel regions of code, the control flow is typically outside of the parallel region and repetitive calls are performed for allocating and freeing the same pool of worker threads. This is depicted in FIG. 4A.

As shown in FIG. 4A, the particular OpenMP function call depicted involves a master thread 410, i.e. a thread that spawns other threads, calling a thread allocation sub-function (alloc) 420 of the OpenMP function 410 which in turn spawns a plurality of worker threads 422-428. When the worker threads complete their operations, they call an OpenMP barrier function (barrier) 430. When all of the worker threads have called the barrier function 430, the worker threads are freed 440 back into the pool of worker threads so that they may be reallocated at a later time, such as during the next iteration of the loop (represented by the line 450).

As can be seen from FIG. 4A, such loops involve repetitive calls to allocate worker threads and free the same pool of worker threads for each iteration of the loop. As shown in FIG. 4B, the compiler of the illustrative embodiments, as one of the optimizations that may be performed by the compiler may migrate the control flow inside the parallel region by breaking the OpenMP function call 410 into the separate sub-functions of alloc 420, barrier 430, and free 440. That is, instead of calling one large OpenMP function 410, the large OpenMP function 410 is broken down into its individual components of alloc 420, barrier 430, and free 440, such that for each worker thread 422-428, separate calls are performed to each of these sub-functions 420, 430, and 440. As such, when the alloc function 420 allocates worker threads each worker thread 422-428 is individually managed by control logic.

Thus, in the operation outlined in FIG. 3 above, the compiler, when selecting regions of code to be analyzed (step 340), the compiler identifies a region of code that calls a function 410 of the OpenMP standard that causes a parallel execution of code, i.e. a parallel region of code. As mentioned above, such parallel regions of code typically are present in loops and similar constructs of source code. Thus, in one illustrative embodiment, the compiler may identify loops in the source code and selects such loops as regions of code for further analysis in accordance with the illustrative embodiments. Having identified that region of code, the compiler analyzes the OpenMP function calls/directives of that region of code. In the example of FIG. 4A, the compiler would identify the function 410 being an OpenMP function call performed in the region of code.

The compiler may then gather information about the region of code, such as which sub-functions 420, 430, and 440 are called in the region of code. A corresponding invocation tree data structure may be generated that identifies what functions are called by other functions. For example, in the depicted example of FIGS. 4A and 4B, the invocation tree data structure would show that the alloc function 420 spawns threads 422-428 which in turn call the barrier function 430, which in turn calls the free function 440.

The invocation tree data structure is analyzed by the compiler to determine, at each node in the tree data structure, what library functions are needed in a customized runtime library to support the required functionality of the function calls in the region of code. This may involve only a subset of the functions of the particular standard. That is, if the standard states that the runtime library must include sub-functions A-D to support a call to function 410, yet the call to function 410 in actuality only ever utilizes sub-functions A, B, and D, then it is not necessary to include sub-function C in the customized runtime library. The analysis of the invocation tree data structure performed by the compiler identifies what sub-functions are actually utilized in the region of code and includes only those sub-functions in the actual customized runtime library for the source code, or the region of source code.

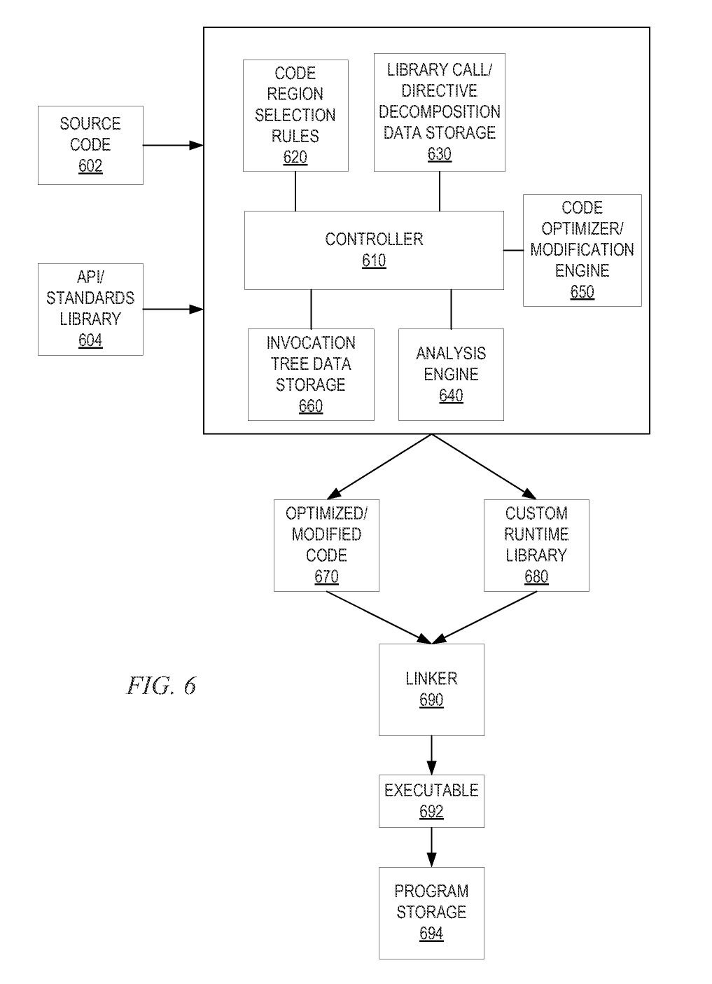

For example, as shown in FIG. 5A, in one region of source code, through the mechanisms of the illustrative embodiments, the compiler may determine that the region of code 500 called by the master thread 502, involving the function call 510, calls alloc function 520, which in turn spawns threads 522-528. Each of the threads 522-528 make a call to a “get-thread-id” sub-function 530, the barrier sub-function 540, and a free sub-function 550. Thus, the customized runtime library generated by the compiler in this case would include the functions for each of these sub-functions 520-550. However, as shown in FIG. 5B, in another region of code in another portion of source code 560, the threads 522-528 do not call the “get-thread-id” sub-function 530, i.e. in their operation, the worker threads 522-528 do not need to query the thread id to perform their operations. As a result, the compiler will determine that there is no need to include support for the “get-thread-id” sub-function 530 in the custom runtime library since this sub-function 530 is not actually used in the region of code 560. Thus, in one instance (FIG. 5A), support for the “get-thread-id” sub-function 530 is included in the customized runtime library, however in the other instance (FIG. 5B), support for the “get-thread-id” sub-function 530 is not included in the customized runtime library.

Thus, with the illustrative embodiments, a compiler may analyze regions of source code that implement a construct of an API or standard to determine which portions of the API or standard are actually implemented or used in the region of code. From this analysis, a customized runtime library may be built that includes only the functions and support for the portions of the API and standards that the source code actually uses or implements. In this way, the customized runtime library represents the minimum function support required to support the compiled source code. The compiler may then insert and/or replace function calls in the source code with calls to the corresponding functions in the customized runtime library. In this way, a reduced size customized runtime library is obtained.

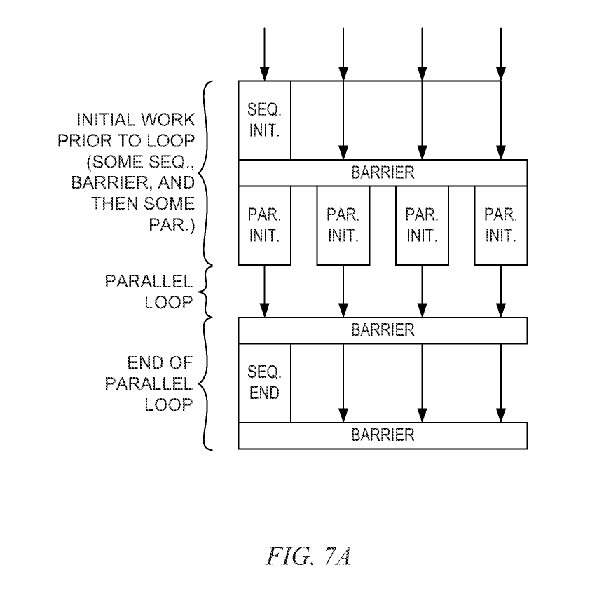

FIG. 6 is a block diagram of a compiler in accordance with one illustrative embodiment. The elements in FIG. 6 may be implemented in hardware, software, or any combination of hardware and software. In one illustrative embodiment, the elements in FIG. 6 are implemented as software instructions executed on one or more processors, such as processing unit 206 in FIG. 2, for example, of one or more data processing systems, such as data processing system 200 in FIG. 2, for example.

As shown in FIG. 6, the compiler 600 includes a controller 610, code region selection rules storage 620, library call/directive decomposition data structure 630, analysis engine 640, and code optimizer/modification engine 650. The compiler 600 further generates an invocation tree which is stored in invocation tree storage 660. The compiler 600 receives, as input, the source code 602 and API/standards libraries 604. The API/standards libraries 604 are complete or full libraries having all of the functions and specifying all of the standards for the APIs and/or standards that are to be implemented in the source code 602 and for which the source code 602 is to be optimized by the compiler 600. The compiler 600 generates optimized and modified code 670, which may be object code for example, along with a corresponding customized runtime library 680 for the optimized and modified code 670. This optimized and modified code 670 and custom runtime library 680 are input to a linker 690 which combines the objects in the optimized and modified code 670 with the objects of the custom runtime library 680 to generate executable code 692. The executable code 692 is stored in a storage device 694 for later execution by one or more processors of one or more data processing systems.

In accordance with the illustrative embodiments, the compiler 600 operates on the source code 602 to identify regions in the source code 602 where the APIs and standards corresponding to the API/standards libraries 604 are implemented. For example, the controller 610 of the compiler 600 may operate in accordance with the code region selection rules 620 to analyze the source code 602 to select one or more regions of code in the source code 602 that meet criteria specified in such rules 620. Using the OpenMP standard as an example, the code region selection rules 620 may specify particular OpenMP function calls that are indicative of a code region that is to be selected. In another example, the code region selection rules 620 may specify loop constructs that indicate regions of code to be selected. The particular code region selection rules 620 and their application may be implementation specific. For example, OpenMP pragmas, Le. a special annotation of the code that follows a semantic specified by the OpenMP standard, may be used to identify regions of code that are to be processed according to the OpenMP standard. Thus identifying a region of code to select for analysis may comprise the compiler searching for these OpenMP pragmas to identify regions of code, analyze the code within each region, and recursively analyze code regions that are also called from within a selected region of code, so as to see the whole picture of the code that may be called (or that dynamically belongs to the called code) within an OpenMP region.

In addition, the controller 610, in conjunction with the analysis engine 640, either earlier, thereafter, or at substantially a same time as the selection of regions of code in the source code 602, operates to analyze the API/standards libraries 604 to identify library calls/directives that can be decomposed into sub-functions. The decomposition information obtained by the analysis of the API/standards libraries 604 may be used to generate and store the library call/directive decomposition data structure stored in the storage 630, which may be a memory, storage device, or the like. The information stored in the library call/directive decomposition data structure may include, for example, a correlation between the original API/standard function in the API/standards libraries 604 and the corresponding collection of two or more sub-functions into which the API/standard function may be decomposed into. If there is no entry in the library call/directive decomposition data structure for a particular API/standard function, then the particular API/standard function cannot be decomposed into two or more sub-functions.

For example, consider an OpenMP construct “#pragma amp parallel”, indicating that the region of code following the pragma is to be executed in parallel. The OpenMP standard indicates how many threads must be allocated to the parallel task, that a barrier operation be called by each thread once the thread completes the region of code following the pragma, and that each of the additional threads that were allocated for the parallel region of code must be released for subsequent parallel execution of regions of code. This construct consists of a single function whose functionality is fully described by the OpenMP standard. In current OpenMP implementations, this single function is implemented as a single call to a runtime library. Because this single function is implemented as one call, it is not feasible to involve the compiler in optimizing and reducing the overhead of the single runtime library call. Thus, in accordance with the illustrative embodiments, the function is broken down into sub-functions, in this case at least 3 sub-functions: one to allocate threads, one to perform the barrier, and one to free the threads. Once the function is broken down into the sub-functions, the placement of the sub-functions may be optimized. For example, the sub-functions may be introduced in the expected (i.e. where expected as defined by the standard) place and then have a different compiler phase that optimizes and moves the sub-functions around. Alternatively, these sub-functions may not be introduced in the expected place and directly migrate them to more advantageous places.

The selected region(s) of code that are selected by the controller 610 based on the code region selection rules 620 are analyzed by the analysis engine 640 based on the library call/directive decomposition data structure 630 to generate an invocation tree 660. That is, the various functions and sub-functions of the API(s)/standard(s) specified in the library call/directive decomposition data structure are compared against the functions identified in the selected code region and the corresponding invocation tree is generated and stored in the invocation tree storage 660.

The analysis engine 640 further analyzes the invocation tree stored in the invocation tree storage 660 to identify the functions/sub-functions invoked by the selected region of code. The identified functions/sub-functions are added to a custom runtime library 680 for the source code. This is done for each selected region of code so that the custom runtime library 680 comprises only the functions/sub-functions that actually are used or invoked by the source code 602. Thus, the custom runtime library 680 may be a sub-set of the full API/standards libraries 604 that were provided as input to the compiler 600. In addition, the code optimizer/modification engine 650 modifies and optimizes the source code to make calls to the functions/sub-functions in the invocation tree 660, and thus, the functions/sub-functions in the custom runtime library 680. Typically, a compiler would know about a standard like OpenMP and know enough to transform each of the OpenMP directives (e.g., stylized comments defined by the OpenMP standard) to transform the region as requested by the OpenMP standard (for example, transforming an “#pragma omp parallel” followed by a region of code into a parallel version of this region of code). However, typical compilers are not aware of how to transform a single function into a sequences of sub-function that the compiler knows about, and thus can later optimize such sub-functions. The illustrative embodiments provide mechanisms that are able to transform such a single function into a sequence of sub-functions that he compiler may later optimize.

The resulting optimized/modified code 670 is output, along with the custom runtime library 680, to the linker 690. The linker 690 generates an executable code 692 based on the optimized/modified code 670 and the custom runtime library 680. The executable code 692 may be stored in the storage 694 for later execution by a processor.

Thus, the illustrative embodiments provide mechanisms for generating customized runtime libraries based on the actual functions/sub-functions of an API/standard used or implemented by the source code being compiled. In this way, a minimized runtime library is generated and used by the linker 690 to generate executable code.

The illustrative embodiments provide a technique where, for example, functions defined by a standard, such as the OpenMP standard, are broken down into a sequence of smaller sub-functions and the compiler is made aware of these sub-functions and their effect on the runtime environment, so as to let the compiler optimize them, for example by moving some of the sub-functions outside of an inner loop, so as to reduce the overhead of implementing the function. Though the transformed program does not strictly abide by the OpenMP standard, the compiler first makes sure that any of the transformation's effects cannot be observed by the program. Because they cannot be observed, it is then legal to transform the program. If the transformation's effects can be observed, e.g., the user has inserted some calls to the runtime library returning specific information whose result would be impacted by moving the sub-function around, then the compiler will not move the sub-functions in such a way. The compiler also fully analyzes the regions of code impacted by the OpenMP directives. When the compiler sees that aspects of the OpenMP standards are not required because the user does not retrieve/use specific parts of the standards, then the compiler does not call functions or sub-functions that implement the unused part of the standards.

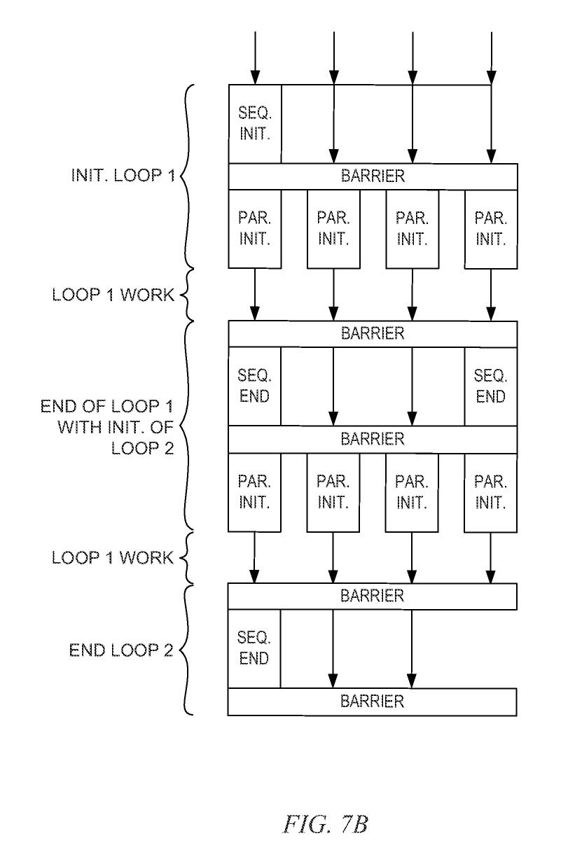

FIGS. 7A and 7B provides an example illustration of the ability of the illustrative embodiments to move sub-functions to achieve more efficient execution of code. The example shown in FIGS. 7A and 7B is directed to a loop with reduction operations. That is, a reduction is an operation that reduces some result into a single value, e.g., “for(every value of i from 0 to N) res=res+val[i]” is a reduction where res is accumulating (reducing) every value of the array val[i] into a single sum. Examples of reduction operations include sum, multiply, minimum, maximum, etc.

Parallel reduction is a reduction operation that is done by more than one thread at once. OpenMP defines that each thread will first reduce its share of the values into a private copy of the data, and then once the parallel region or parallel loop is completed, then the final copy of the value is obtained by further reducing the private copy of each thread. Thus, in the example above, if one wants to do a parallel reduction of val[i] with 2 threads, one would first generate two copies of res, i.e. res_private[0] and res_private[1]. Then, the first thread would initialize res_private[0] to zero, and sum its half of the loop (such as i values 0 to N/2) into its private version of the variable, i.e. res_private[0]. Then the first thread would call a barrier operation (enter a barrier) to indicate it has completed its work. The second thread would, in parallel, initialize its private value, res_private[1], to zero, and sum its half of the loop (such as i values N/2+1 to N) into its private version of the variable, i.e. res_private[1]. The second thread would then enter the barrier to indicate that it has also completed its work. One of the two threads would then determine that all of the threads have finished their work and would then sum res_private[0] with res_private[1] into res and indicate completion by entering a barrier.

Looking at FIG. 7A, in these figures the “seq. init” is the portion of the process described above where one of the threads creates its private copy of the result array, e.g., res_private[]. Once this is created, the address of the private copy is given to all of the threads in the parallel region of code (e.g., the loop). Each thread performs the initialization of its private value in the array, executes its portion of the parallel region of code (loop), including the operations specified by the reduction into its private value in the array, and enters a barrier. One thread then completes the reduction once all threads have entered a barrier, i.e. seq. end, and then enters a barrier to indicate completion of the reduction.

Typically, the reduction is seen as one overall function and is not broken down into its constituent parts. However, with the mechanisms of the illustrative embodiments, this one function may be broken into sub-functions, such as sequential_init (seq. init.), parallel_int (par.init.), and sequential_end (seq. end) in FIGS. 7A and 7B. Once broken down in this manner, the compiler is able to optimize and move or migrate these sub-functions to achieve greater efficiency in the execution of the code. FIG. 7B illustrates one example of a migrated portion of code where sub-functions are moved or rearranged. In FIG. 7B, the sub-functions are moved such that the sequential_end of a first reduction operation is executed in parallel with the sequential_ini of the next parallel execution, for example. Thus, the illustrative embodiments allow the compiler greater functionality with regard to optimizing the execution of calls to runtime library functions and the placement of execution of these runtime library calls in the executing code.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system comprising at least one processor and a memory, for generating a customized runtime library for source code, comprising:
analyzing, by the data processing system, source code to identify a region of code implementing an application programming interface or programming standard of interest;
generating, by the data processing system, an invocation tree data structure based on results of analysis of functions of the application programming interface or programming standard of interest that the region of code invokes; and
generating, by the data processing system, a custom runtime library based on the invocation tree data structure, wherein the custom runtime library comprises only a subset of runtime library functions, less than a total number of runtime library functions for the application programming interface or programming standard of interest, actually invoked by the region of code and does not include all runtime library functions in the total number of runtime library functions for the application programming interface or programming standard of interest.

2. The method of claim 1, wherein the application programming interface or programming standard of interest is the OpenMP standard.

3. The method of claim 1, wherein the method is performed by a compiler executing on the data processing system.

4. The method of claim 1, further comprising:
receiving one or more complete libraries of runtime library functions supported by the application programming interface or programming standard of interest, the one or more complete libraries comprising the total number of runtime library functions;
analyzing runtime library functions in the one or more complete libraries of functions to identify sub-functions of the runtime library functions; and
comparing the identified sub-functions of the runtime library functions to operations performed by the source code based on the invocation tree data structure to identify sub-functions of the runtime library functions that would be invoked by the source code during runtime, wherein generating the custom runtime library comprises adding the identified sub-functions of the runtime library functions that would be invoked by the source code during runtime as part of the subset of runtime library functions in the custom runtime library.

5. The method of claim 4, wherein comparing the identified sub-functions of the runtime library functions to operations performed by the source code based on the invocation tree data structure comprises traversing the invocation tree data structure in a depth-first fashion and determining, at each node of the invocation tree data structure which sub-functions of the runtime library functions, if any, would be invoked by code corresponding to the node.

6. The method of claim 1, further comprising:
inserting, by the data processing system, at least one call to the customized runtime library into the source code to generate modified code;
generating, by the data processing system, compiled code based on the modified code; and
outputting the compiled code and customized runtime library for execution by one or more computing devices, wherein the compiled code comprises the at least one call to the customized runtime library and utilizes the customized runtime library when executed.

7. The method of claim 1, wherein analyzing source code to identify a region of code implementing an application programming interface or programming standard of interest comprising selecting only regions of the source code that are defined in the source code as parallel execution regions of code.

8. The method of claim 7, wherein selecting only regions of source code that are defined in the source code as parallel execution regions of code comprises identifying the parallel execution regions of code based on a call to an OpenMP function that causes parallel execution of a subsequent region of code.

9. A computer program product comprising a computer readable storage medium having a computer readable program stored therein, wherein the computer readable program, when executed on a computing device, causes the computing device to:
analyze source code to identify a region of code implementing an application programming interface or programming standard of interest;
generate an invocation tree data structure based on results of analysis of functions of the application programming interface or programming standard of interest that the region of code invokes; and
generate a custom runtime library based on the invocation tree data structure, wherein the custom runtime library comprises only a subset of runtime library functions, less than a total number of runtime library functions for the application programming interface or programming standard of interest, actually invoked by the region of code and does not include all runtime library functions in the total number of runtime library functions for the application programming interface or programming standard of interest.

10. The computer program product of claim 9, wherein the application programming interface or programming standard of interest is the OpenMP standard.

11. The computer program product of claim 9, wherein the computer readable program comprises a compiler executing on the computing device.

12. The computer program product of claim 9, wherein the computer readable program further causes the computing device to:
receive one or more complete libraries of runtime library functions supported by the application programming interface or programming standard of interest, the one or more complete libraries comprising the total number of runtime library functions;
analyze runtime library functions in the one or more complete libraries of functions to identify sub-functions of the runtime library functions; and
compare the identified sub-functions of the runtime library functions to operations performed by the source code based on the invocation tree data structure to identify sub-functions of the runtime library functions that would be invoked by the source code during runtime, wherein generating the custom runtime library comprises adding the identified sub-functions of the runtime library functions that would be invoked by the source code during runtime as part of the subset of runtime library functions in the custom runtime library.

13. The computer program product of claim 12, wherein the computer readable program further causes the computing device to compare the identified sub-functions of the runtime library functions to operations performed by the source code based on the invocation tree data structure by traversing the invocation tree data structure in a depth-first fashion and determining, at each node of the invocation tree data structure which sub-functions of the runtime library functions, if any, would be invoked by code corresponding to the node.

14. The computer program product of claim 9, the computer readable program further causes the computing device to:
insert at least one call to the customized runtime library into the source code to generate modified code;
generate compiled code based on the modified code; and
outputting the compiled code and customized runtime library for execution by one or more computing devices, wherein the compiled code comprises the at least one call to the customized runtime library and utilizes the customized runtime library when executed.

15. The computer program product of claim 9, wherein the computer readable program further causes the computing device to analyze source code to identify a region of code implementing an application programming interface or programming standard of interest by selecting only regions of the source code that are defined in the source code as parallel execution regions of code.

16. The computer program product of claim 15, wherein the computer readable program further causes the computing device to select only regions of source code that are defined in the source code as parallel execution regions of code by identifying the parallel execution regions of code based on a call to an OpenMP function that causes parallel execution of a subsequent region of code.

17. An apparatus, comprising:
a processor; and
a memory coupled to the processor, wherein the memory comprises instructions which, when executed by the processor, cause the processor to:
analyze source code to identify a region of code implementing an application programming interface or programming standard of interest;
generate an invocation tree data structure based on results of analysis of functions of the application programming interface or programming standard of interest that the region of code invokes; and
generate a custom runtime library based on the invocation tree data structure, wherein the custom runtime library comprises only a subset of runtime library functions, less than a total number of runtime library functions for the application programming interface or programming standard of interest, actually invoked by the region of code and does not include all runtime library functions in the total number of runtime library functions for the application programming interface or programming standard of interest.

18. The apparatus of claim 17, wherein the application programming interface or programming standard of interest is the OpenMP standard.

19. The apparatus of claim 17, wherein the instructions comprise a compiler executing on the processor.

20. The apparatus of claim 17, wherein the instructions further cause the processor to:
receive one or more complete libraries of runtime library functions supported by the application programming interface or programming standard of interest, the one or more complete libraries comprising the total number of runtime library functions;
analyze runtime library functions in the one or more complete libraries of functions to identify sub-functions of the runtime library functions; and
compare the identified sub-functions of the runtime library functions to operations performed by the source code based on the invocation tree data structure to identify sub-functions of the runtime library functions that would be invoked by the source code during runtime, wherein generating the custom runtime library comprises adding the identified sub-functions of the runtime library functions that would be invoked by the source code during runtime as part of the subset of runtime library functions in the custom runtime library.

21. The apparatus of claim 20, wherein the instructions further cause the processor to compare the identified sub-functions of the runtime library functions to operations performed by the source code based on the invocation tree data structure by traversing the invocation tree data structure in a depth-first fashion and determining, at each node of the invocation tree data structure which sub-functions of the runtime library functions, if any, would be invoked by code corresponding to the node.

22. The apparatus of claim 17, wherein the instructions further cause the processor to:
insert at least one call to the customized runtime library into the source code to generate modified code;
generate compiled code based on the modified code; and
output the compiled code and customized runtime library for execution by one or more computing devices, wherein the compiled code comprises the at least one call to the customized runtime library and utilizes the customized runtime library when executed.

23. The apparatus of claim 17, wherein the instructions further cause the processor to analyze source code to identify a region of code implementing an application programming interface or programming standard of interest by selecting only regions of the source code that are defined in the source code as parallel execution regions of code.

24. The apparatus of claim 23, wherein the instructions further cause the processor to select only regions of source code that are defined in the source code as parallel execution regions of code by identifying the parallel execution regions of code based on a call to an OpenMP function that causes parallel execution of a subsequent region of code.
